(19) United States
(12) Patent Application Publication
(10) Pub. No.: US 2011/0223337 A1
(43) Pub. Date: Sep. 15, 2011

(54) Extrusion coating apparatus and coating method as well as coating film forming method

(75) Inventors: Hiroki Yanagawa, Minami-Ashigara-shi (JP); Kenichi Yasuda, Minami-Ashigara-shi (JP); Shinya Katoh, Minami-Ashigara-shi (JP); Kazuhiro Oki, Minami-Ashigara-shi (JP)

(73) Assignee: FUJIFILM Corporation, Tokyo (JP)

(21) Appl. No.: 13/064,273

(22) Filed: Mar. 15, 2011

(30) Foreign Application Priority Data
Mar. 15, 2010 (JP) 2010-057867

(51) Int. Cl. B05D 3/12; B05C 11/00

(52) U.S. Cl. 427/350; 118/50

(57) ABSTRACT

The present invention provides an extrusion coating apparatus which can control the coating shape in end portions regardless of the coating thickness and can suppress high edges. The extrusion coating apparatus includes a coating width regulating plate inserted into both end portions of a slit, a slit die discharging the coating solution from a discharge opening of the slit, and a chamber depressurizing in a web running direction on an upstream side. The coating width regulating plate has a protruded portion bent toward the web downstream side and facing the web. The coating solution is applied to the web in a state in which the coating solution is oozed on a web facing surface of the protruded portion of the coating width regulating plate by depressurization of the chamber.

### BACKGROUND OF THE INVENTION

1. Field of the Invention

The present invention relates to an extrusion coating apparatus and a coating method as well as a coating film forming method, and more particularly to an extrusion coating apparatus and a coating method as well as a coating film forming method for applying a coating solution to a continuously running web.

2. Description of the Related Art

The extrusion coating apparatus is configured such that a coating solution supplied to a pocket portion of a slot die is spread in a coating width direction (same as the web width direction) by the pocket portion, and then the coating solution is discharged from a distal end of a slit (also referred to as a slot) having a narrow gap communicatively connected to the pocket portion. Meanwhile, a web to which the coating solution is applied runs in the state of being wound around a backup roller. A bead of coating solution (reservoir of coating fluid) discharged from the distal end of the slit is formed in a lip clearance between the distal end of the slot die and the web. Through the bead, the coating solution is applied to the web.

The coating width of the coating solution to be applied to the web needs to be changed according to the web width and is regulated by the distance between the coating width regulating plates (spacers) inserted into both end portions in the slit width direction (same as the web width direction).

Even if such an extrusion coating apparatus arranges die discharge openings to have a uniform gap, unstable beads in end portions in the bead width direction cause a film thickness distribution in the width direction of the applied coating film.

In light of this, Japanese Patent Application Laid-Open No. 2009-220025 discloses an extrusion coating apparatus which stabilizes a bead state in both end portions using a coating width regulating plate in which at least a distal end portion is made of a flexible member and the distal end portion is protruded from the distal end of the slot.

Japanese Patent Application Laid-Open No. 2000-153199 discloses an extrusion coating apparatus which includes a shim with a shape allowing the shape of a coating solution passage to be changed over the longitudinal direction of the discharge opening and the direction of discharging the coating solution in such a manner that the distribution of the discharged coating solution changes over the longitudinal direction of the discharge opening so as to prevent the increase in film thickness (high edge) in the end portions due to surface tension and other effects.

### SUMMARY OF THE INVENTION

However, the extrusion coating apparatus disclosed in Japanese Patent Application Laid-Open No. 2009-220025 is adapted for use in forming a thin coating film without considering the high edges in end portions of the coating film, and thus cannot prevent the high edges. Further, the extrusion coating apparatus disclosed in Japanese Patent Application Laid-Open No. 2000-153199 can suppress high edges by reducing the amount of discharge of a coating solution in both end portions, but unfortunately cannot control the coating shape in end portions.

In view of above considerations, the present invention has been made, and an object of the present invention is to provide an extrusion coating apparatus and method which can control the coating shape in end portions and can suppress high edges regardless of the coating thickness.

In order to achieve the above object, the present invention provides an extrusion coating method for use in an extrusion coating apparatus having a slit die for discharging a coating solution from a discharge opening of a slit and applying the coating solution to a continuously running web, the extrusion coating method including oozing the coating solution in between the web and a coating width regulating plate which is inserted in both end portions of the slit and has a protruded portion bent toward a downstream side of the web and facing the web, by depressurization of a chamber, and applying the oozed coating solution to the web.

In order to achieve the above object, the present invention provides an extrusion coating apparatus having a slit die for discharging a coating solution from a discharge opening of a slit and applying the coating solution to a continuously running web, the extrusion coating apparatus including a coating width regulating plate which is inserted into both end portions of the slit, a protruded portion which is provided at the coating width regulating plate and is bent toward a downstream side of the web to face the web, and a chamber which is provided at a web-facing surface of the protruded portion of the coating width regulating plate, the chamber for oozing the coating solution in between the web and the web-facing surface by depressurizing the chamber, wherein the oozed coating solution is applied to the web.

The extrusion coating method and apparatus of the present invention can suppress high edges regardless of coating thickness using a coating width regulating plate (also referred to as a spacer) having a protruded portion bent toward a downstream side of the web and facing the web to depressurize a chamber. Particularly, when the coating film is thick (approximately a thickness of 10 μm or more), the thickness of the end portions increases due to effects of surface tension, thereby causing a remarkable high edge. However, the high edge can be effectively suppressed by contacting the coating width regulating plate to the web, pulling the coating solution in end portions toward the coating width regulating plate side due to depressurization, and oozing the coating solution in between the coating width regulating plate and the web for thin coating.

Further, according to the present invention, the coating width regulating plate is protruded and bent in contact with the web. Thus, oozing the coating solution in between the web and the coating width regulating plate can be controlled by adjusting the pressure of the chamber and/or the thickness of the protruded portion of the coating width regulating plate and the film shape of the coating film end portions can be controlled.

The protruded portion of the coating width regulating plate according to the present invention is preferably made of a flexible material so as not to damage the web and so as to easily ooze the coating solution. As the flexible material, Teflon (registered trademark) is preferred.

Further, the present invention provides a coating film forming method comprising applying the coating solution by the coating method of the present invention.

The extrusion coating apparatus of the present invention can suppress high edges when a product with various coating thicknesses using various coating solutions is manufactured. Thus, the coating method and the coating film forming method of the present invention can provide a coating film with a high edges suppressed.

As described above, the extrusion coating apparatus of the present invention can control the coating shape in coating end portions and can suppress high edges regardless of the coating thickness.

### BRIEF DESCRIPTION OF THE DRAWINGS

FIG. 1 is a plan view of an extrusion coating apparatus of the present invention as seen from above;

FIG. 2 is a sectional side view of the extrusion coating apparatus of the present invention;

FIG. 3 is a perspective view of the extrusion coating apparatus of the present invention;

FIG. 4 is a perspective view illustrating a manner in which a coating solution is applied by the extrusion coating apparatus of the present invention;

FIG. 5 is a graph describing an advantage of the present invention; and

FIG. 6 is a table illustrating embodiments and comparable examples showing the advantage of the present invention.

### DETAILED DESCRIPTION OF THE PREFERRED EMBODIMENTS

Now, by referring to the accompanying drawings, a preferred embodiment of the extrusion coating apparatus according to the present invention will be described in detail.

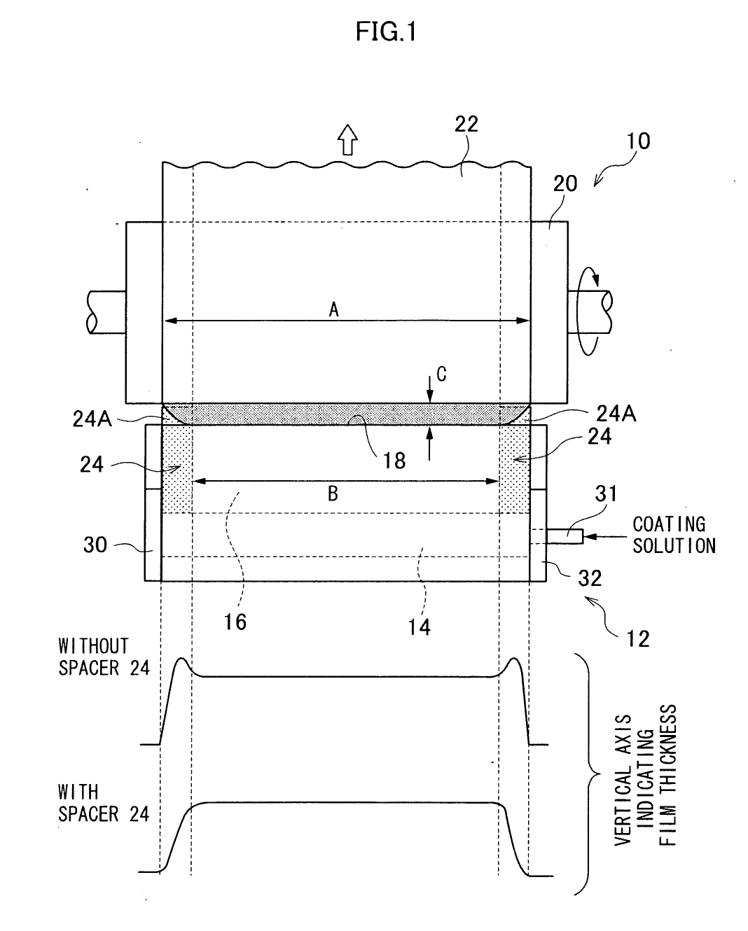

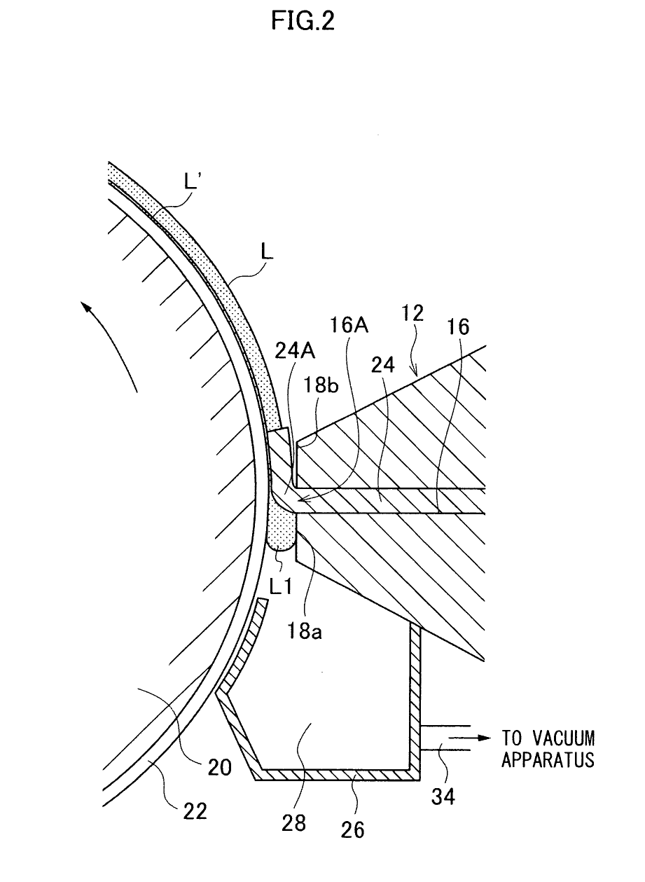

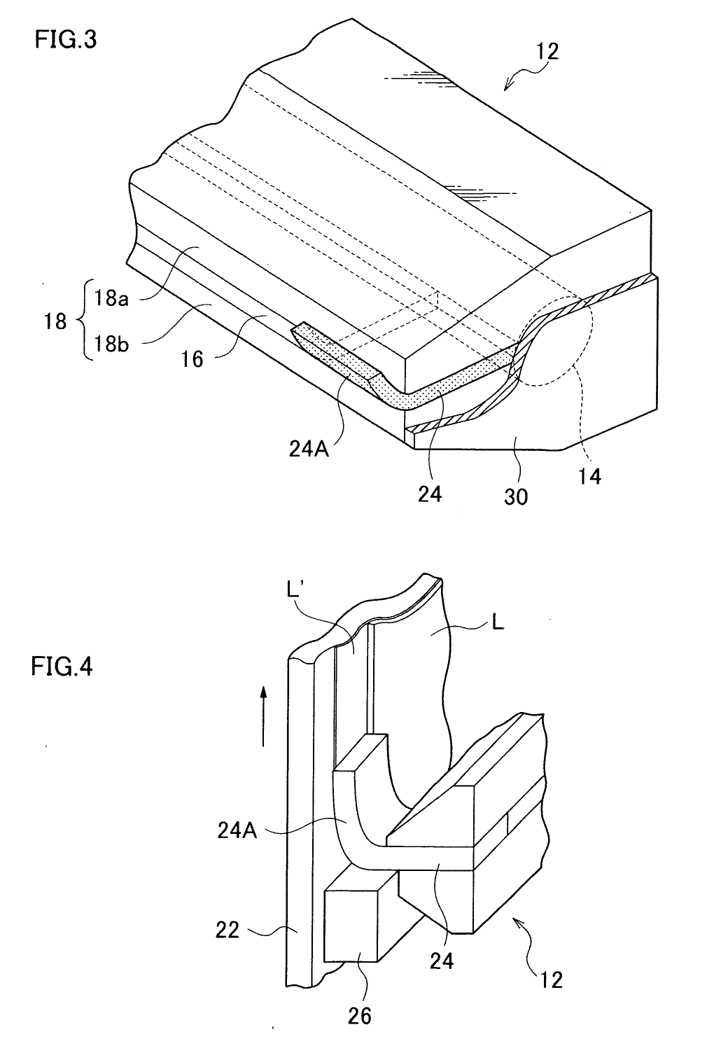

FIG. 1 is a plan view of an extrusion coating apparatus 10 of the present invention as seen from above; FIG. 2 is a sectional side view thereof; and FIG. 3 is a perspective view illustrating the essential parts thereof.

As illustrated in these figures, a slot die 12 includes a pocket portion 14 inside a head thereof and a narrow slit 16 communicatively connected to the pocket portion 14. A coating solution discharge opening at a distal end of the slit 16 opens on a substantially flat lip surface 18 (18a (upstream side) and 18b (downstream side)) at a distal end of the head. A both end opening portion through which the pocket portion 14 passes is blocked by side plates 30 and 32 provided on both end surfaces of the slot die 12.

The both end opening portion is connected to a liquid supply line 31 which supplies a coating solution to the pocket portion 14 through one side plate 32. Note that the method of supplying a coating solution to the pocket portion 14 is not limited to the method of supplying a coating solution from one side by blocking the other end side of the pocket portion 14. For example, a coating solution may be supplied from a central portion of the pocket portion 14 so as to be split to both ends, or a coating solution may be supplied from one side of the pocket portion 14 so as to be pulled out from the other direction.

In FIGS. 1 to 3, a backup roller 20 is arranged close to and opposite to the lip surface 18 of the slot die 12. A web 22 to which a coating solution L is applied is supported by being wound around the backup roller 20 and continuously runs in a direction indicated by the arrow. The gap between the lip surface 18 at the distal end of the die and the backup roller 20 is generally set in a range from 30 μm to 300 μm. The gap is set appropriately according to the coating thickness, the coating speed, the property (viscosity, etc.) of the coating solution L, and like.

Thereby, the coating solution L discharged from the slit 16 is cross-linked between the lip surface 18 and the web 22 to form a bead L1 (reservoir of coating fluid, see FIG. 2). Then, through the bead L1, the coating solution L is applied to the web 22.

Note that as illustrated in FIG. 1, a coating width A of the coating solution L applied to the web 22 is regulated by an interval (distance) B between a pair of spacers 24 inserted into both end portions in the width direction (same as the web width direction) of the slit 16.

Then, the coating solution supplied to the pocket portion 14 of the slot die 12 widely flows in the web width direction in the pocket portion 14, rises through the slit 16, and is discharged from the slit discharge opening 16A. The discharged coating solution is applied to the web 22 while forming a bead between the lip surface 18 of the coating head and the web 22 running close to the lip surface 18. More specifically, the coating solution is applied to the web under a balanced condition between a discharging force of the coating solution discharged from the discharge opening 16A (see FIG. 2) at the distal end of the slit and a pressing force of the web 22 pressing the distal end portion of the coating head. Accordingly, an extremely thin coating film is formed on the web surface.

Here, according to the present invention, the spacer 24 is protruded from the distal end of the slit 16 so as to face the surface of the web 22 wound around the backup roller 20. Further, the spacer 24 according to the present invention has a protruded portion 24A facing the web 22 and bent toward the downstream side of the web.

Further, according to the present invention, as illustrated in FIG. 2, a chamber 26 is provided below a bead L1 so as to depressurize the bead L1 on the upstream side in the web running direction thereof. The chamber 26 is formed into a box shape, and the upper surface of the box opens in an elongated shape in the web width direction. Then, an enclosed space 28 is formed of one lip surface 12A of the slot die 12 and a surface of the web 22 supported by the backup roller 20. A pipe 34 coupled to an unillustrated vacuum apparatus is connected to the chamber 26. An enclosed space 28 is depressurized by driving the vacuum apparatus. Note that a buffer tank (unillustrated) is preferably provided between the chamber 26 and the vacuum apparatus so as not to change the degree of depressurization in the enclosed space 28.

The present invention can suppress high edges using the spacer 24 having a protruded portion 24A facing the web and bent toward the web downstream side to depressurize the inside of the enclosed space 28 regardless of the coating thickness. More specifically, as illustrated in FIGS. 1 and 4, high edges can be effectively suppressed by pulling the coating solution in end portions toward the spacer 24 side due to depressurization so as to ooze into the spacer bottom for thin coating.

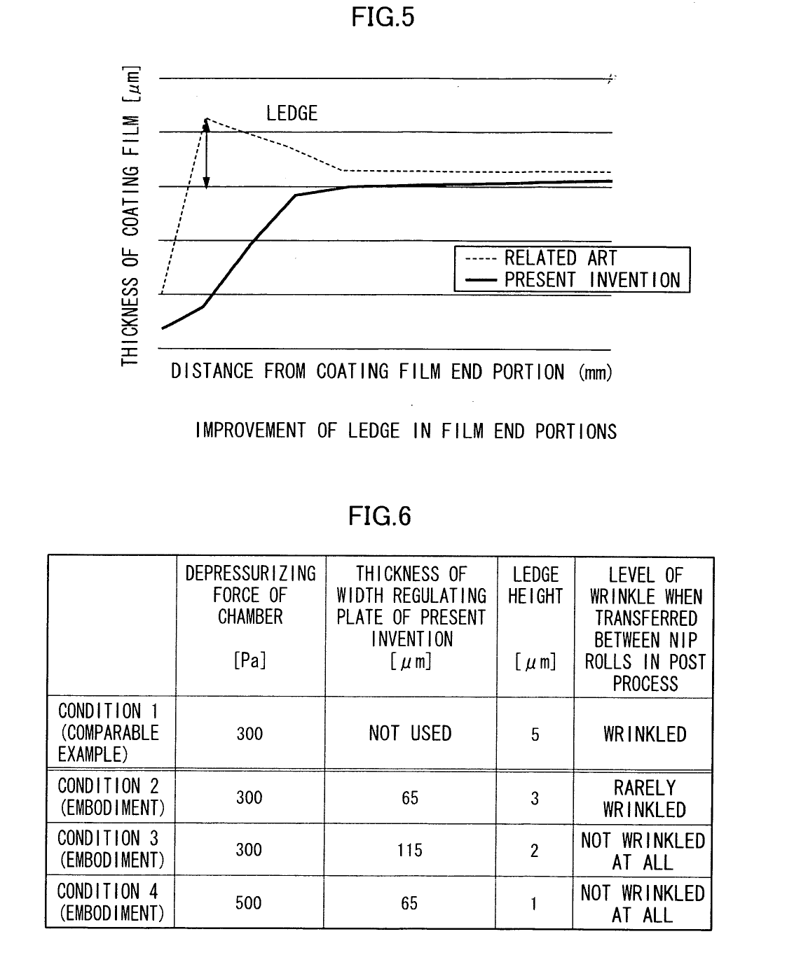

FIG. 5 is a graph illustrating a comparison of the thicknesses of coating film end portions between the extrusion coating apparatus of the present invention and an extrusion coating apparatus in prior art. Conventionally, the thickness of end portions increases due to effects of surface tension of the coating solution (see also “without spacer 24” in FIG. 1). In contrast to this, the present invention can suppress high edges by pulling the coating solution in end portions toward the spacer side due to depressurization by the chamber to ooze in between the coating width regulating plate and the web for thin coating (see also “with spacer 24” in FIG. 1). Particularly, when the coating film is thick (approximately a thickness of 10 μm or more), the thickness of the end portions increases due to effects of surface tension, thereby causing a remarkable high edge, but the present invention can effectively suppress high edges.

FIG. 6 is a table illustrating the measurements of coating film thickness in coating film end portions by changing the pressure of the chamber 26 and the width and thickness of the protruded portion 24A of the spacer using the extrusion coating apparatus of the present invention. Under condition 1, as described in FIG. 5, the coating width regulating plate bent in contact with the web according to the present invention is not used. As a result, the high edge in end portions is 5 μm high, and the web is wrinkled when transferred between nip rolls in a post process, which is a problem. Under condition 2, the coating width regulating plate bent in contact with the web according to the present invention is used to ooze the coating solution in the spacer bottom. As a result, the high edge in end portions can be suppressed to 3 μm, which is within an allowable limit of the high edge. In comparison with condition 2, under condition 3, the width of the protruded portion 24A of the spacer and the pressure of the chamber 26 are the same as those under condition 2, but the thickness of the protruded portion 24A of the spacer is changed. An increase in thickness of the protruded portion 24A of the spacer reduces the thickness of the coating film in end portions, thereby preventing high edges. Under condition 4, the width and the thickness of the protruded portion 24A of the spacer and the pressure of the chamber 26 are the same as those under condition 2, but the depressurizing force of chamber 26 is changed. An increase in the depressurizing force of chamber 26 causes more coating solution to be wet and spread in end portions, reducing the thickness of coating film in end portions and thereby preventing high edges in the same manner as under condition 3.

Thus, as understood from FIG. 6, the extrusion coating apparatus of the present invention can control oozing the coating solution and can control film thickness shape of the coating film end portions by adjusting the pressure of the depressurizing chamber and the thickness of the protruded portion of the spacer. Note that when the film thickness of the coating film end portions is greater than the film thickness of the central portion by 3 μm or more, the coating film is wrinkled, for example, when transferred between nip rolls in a post process. Thus, the difference between the film thickness of the coating film end portions and the film thickness of the central portion is preferably suppressed to less than 3 μm.

As the material of the spacer 24 according to the present invention, at least the distal end portion 24A is preferably made of a flexible material. More specifically, preferred are materials difficult to be modified by a solvent and flexible to be modified in a bent shape to some extent such as Teflon (registered trademark), rubber, triacetylcellulose (TAC), polyethylene terephthalate (PET), polyethylene naphthalate (PEN), and like. Further, when rubber is used, a coating such as Teflon (registered trademark) coating, urethane coating, and silicon coating is preferably performed to improve lubricity and wear resistance to contact with the web 22. Alternatively, Teflon (registered trademark), rubber material, molybdenum, oil, and like may be kneaded and mixed to improve lubricity and wear resistance.

Now, the operation of the extrusion coating apparatus 10 configured as described above will be described.

The coating solution L supplied to the pocket portion 14 in the slot die 12 widely flows in the coating width direction (same as the web width direction) in the pocket portion 14, rises through the slit 16 whose coating width is regulated by the pair of spacers 24 and 24, and is discharged from the distal end of the slit. Thereby, the coating solution L is cross-linked in a gap C between the lip surface 18 of the slot die 12 and the web 22 to form a bead L1 (reservoir of coating fluid). Then, the coating solution L is applied to the web 22 to form a coating film.

Particularly, when the coating film is thick (approximately a thickness of 10 μm or more), the thickness of the end portions increases due to effects of surface tension, thereby causing a remarkable high edge.

In light of this, the present invention uses the spacer 24 having the protruded portion 24A facing the web and bent toward the web downstream side to depressurize the chamber 26. High edges can be effectively suppressed by pulling the coating solution in end portions toward the spacer 24 side due to depressurization so as to ooze in between the spacer 24 and the web 22 for thin coating.

The extrusion coating method and apparatus of the present invention can suppress high edges when a product with various coating thicknesses using various coating solutions is manufactured. Further, the present invention can control oozing the coating solution by adjusting the pressure of the depressurizing chamber and the thickness of the protruded portion of the spacer and thus can shape the film thickness shape of the coating film end portions into a desired shape.

It should be noted that the present embodiment has described the preferred shape of the spacer 24, the chamber 26, and like, but is not limited to this shape and may include any shape not departing from the spirit and scope of the present invention.

What is claimed is:

1. An extrusion coating method for use in an extrusion coating apparatus having a slit die for discharging a coating solution from a discharge opening of a slit and applying the coating solution to a continuously running web, the extrusion coating method comprising:
oozing the coating solution in between the web and a coating width regulating plate which is inserted in both end portions of the slit and has a protruded portion bent toward a downstream side of the web and facing the web, by depressurizing a chamber of the extrusion coating apparatus; and
applying the oozed coating solution to the web.

2. The extrusion coating method according to claim 1, further comprising: controlling oozing the coating solution by adjusting the pressure of the chamber and/or the thickness of the protruded portion of the coating width regulating plate to control shape of end portions of the coating film.

3. The extrusion coating method according to claim 1, wherein the protruded portion of the coating width regulating plate is made of a flexible material.

4. The extrusion coating method according to claim 2, wherein the protruded portion of the coating width regulating plate is made of a flexible material.

5. A coating film forming method comprising applying the coating solution by the coating method according to claim 1.

6. An extrusion coating apparatus having a slit die for discharging a coating solution from a discharge opening of a slit and applying the coating solution to a continuously running web, the extrusion coating apparatus comprising:
a coating width regulating plate which is inserted into both end portions of the slit;
a protruded portion which is provided at the coating width regulating plate and is bent toward a downstream side of the web to face the web; and
a chamber which is provided at a web-facing surface of the protruded portion of the coating width regulating plate, the chamber for oozing the coating solution in between the web and the web-facing surface by depressurizing the chamber,
wherein the oozed coating solution is applied to the web.

7. The extrusion coating apparatus according to claim 6, wherein the protruded portion of the coating width regulating plate is made of a flexible material.
